(19) United States
(12) Patent Application Publication
(10) Pub. No.: US 2025/0163978 A1
(43) Pub. Date: May 22, 2025

(54) Hydrostatic Rotary Machine with Optimized Brake

(71) Applicant: Robert Bosch GmbH, Stuttgart (DE)

(72) Inventor: Laurent Eugène Albert, Frignicourt (FR)

(21) Appl. No.: 18/946,225

(22) Filed: Nov. 13, 2024

(30) Foreign Application Priority Data
Nov. 20, 2023 (FR) 2312759

(51) Int. Cl. F16D 51/14

(52) U.S. Cl. CPC F16D 51/14

(57) ABSTRACT

A hydrostatic rotary machine includes (i) an inner element and an outer element which are coaxial and mounted with the ability to rotate one with respect to the other about an axis of rotation, one of these elements being a rotor and the other of these elements being a stator, (ii) a brake counter-disc which is mounted on the distribution hub, which extends radially around the distribution hub, and which is rotationally coupled to the outer element, (iii) a passive-braking piston designed to activate a brake under the effect of an elastic element and which is mounted with axial mobility with respect to the brake counter-disc, and (iv) a hydraulic brake-release chamber positioned between the brake counter-disc and the passive-braking piston.

This application claims priority under 35 U.S.C. § 119 to patent application no. FR 2312759, filed on Nov. 20, 2023 in France, the disclosure of which is incorporated herein by reference in its entirety.

The disclosure relates to the field of mechanics and hydraulics and more particularly relates to a hydrostatic rotary machine.

Hydrostatic rotary machines are rotary machines comprising a stator coupled to a rotor which is generally connected to a rotary drive element such as a wheel, a pinion or some form of transmission device.

Such a hydrostatic machine may be used as a hydraulic motor. It is then supplied with a pressurized hydraulic fluid, and in response drives the rotary drive element.

The hydrostatic machine may also be used as a hydraulic pump. It then receives a torque transmitted by the rotary drive element, and in response compresses the hydraulic fluid

Such a hydrostatic machine may be equipped with a passive or dynamic brake for braking or even immobilizing the rotor.

### BACKGROUND

Patent application EP3233553 describes a hydrostatic rotary machine comprising:
a rotor and a stator;
pistons able to move in cylinders and collaborating with a camway in a manner that is coordinated with the rotation of the rotor with respect to the stator;
a distribution hub solidly attached to the stator;
a hydraulic distributor mounted on the distribution hub and designed to connect the cylinders selectively to a hydraulic circuit;
a brake designed to oppose the rotational movement of the rotor with respect to the stator.

Although this hydrostatic machine offers advantages on a number of levels, it still has scope for improvement regarding optimizing its braking and its compactness.

### SUMMARY

It is an object of the disclosure to improve the rotary hydrostatic machines of the prior art.

To this end, the disclosure intends a rotary hydrostatic machine comprising:
an inner element and an outer element which are coaxial and mounted with the ability to rotate one with respect to the other about an axis of rotation, one of these elements being a rotor and the other of these elements being a stator;
pistons able to move in cylinders and collaborating with a camway in a manner that is coordinated with the rotation of the rotor with respect to the stator;
a distribution hub rotationally coupled to the outer element;
a hydraulic distributor mounted on the distribution hub and designed to connect the cylinders selectively to a hydraulic circuit;
a brake designed to oppose the rotational movement of the rotor with respect to the stator.

This rotary hydrostatic machine additionally comprises:
a brake counter-disc which is mounted on the distribution hub, which extends radially around the distribution hub, and which is rotationally coupled to the outer element;
a passive-braking piston designed to activate said brake under the effect of an elastic element and which is mounted with axial mobility with respect to the brake counter-disc;
a hydraulic brake-release chamber positioned between the brake counter-disc and the passive-braking piston.

Such a hydrostatic machine benefits from a reduction in its weight, its bulk and its cost.

Thanks to the brake counter-disc, the disclosure enables the braking functions to be performed with very few additional components and with such components being simplified. The disclosure notably allows a significant improvement to the lengthwise compactness of the hydrostatic machine.

The disclosure is also able to provide a brake that is equipped with discs of a large diameter, something that promotes good braking performance as well as reducing braking noise. The use of large-diameter brake discs does not impact the bulk of the hydrostatic machine.

The disclosure provides optimized braking thanks to components which, in addition to being few in number, can essentially be machined on a lathe, thereby further ensuring cost reduction.

Passive braking refers here to braking that is activated in the absence of hydraulic-fluid pressure and which is deactivated by a positive action of pressurizing a hydraulic chamber. This passive braking allows for example for the provision of parking braking, and is imperative in most hydrostatic machines. The disclosure is able to optimize this passive braking and, optionally, to add to it dynamic braking which refers here to braking that is activated by a positive action of pressurizing a hydraulic brake-application chamber and which activates a dynamic-braking piston. Dynamic braking is advantageous, or even compulsory, notably on hydrostatic motors powering vehicles moving at above a certain speed.

The disclosure allows the addition of dynamic braking without any modification to the other elements. The disclosure allows the production of hydrostatic machines to be standardized, with a basic model including all the components necessary for the basic functions, and a space for a dynamic-braking piston which may or may not be added depending on the model that is to be produced. Such standardization optimizes costs. This possibility is also advantageous for the designers of equipment using such hydrostatic machines, the design of the equipment having simply to account for the physical features of operation of a standard hydrostatic machine, regardless as to whether or not it is provided with dynamic braking.

The rotary hydrostatic machine according to the disclosure may comprise the following additional features, alone or in combination:
the brake counter-disc is mounted with axial translational mobility on the distribution hub;
the machine comprises an end stop halting the axial translation of the brake counter-disc in the direction of the brake;
the machine comprises an annular supply chamber positioned between the distribution hub and the brake counter-disc, this annular supply chamber being connected on the one hand to the hydraulic brake-release chamber and on the other hand to a hub duct extending from the distribution hub;
the annular supply chamber is delimited by two annular seals positioned between the distribution hub and the brake counter-disc;
the annular supply chamber is defined by two mutually complementing discontinuities in diameter of, respectively, the distribution hub and the brake counter-disc;
the brake counter-disc comprises: a central ring extending axially and mounted on the distribution hub; and a radial portion extending radially from this central ring;
the central ring of the brake counter-disc comprises an outer cylindrical bearing surface, and the passive-braking piston is a component with symmetry of revolution comprising a central orifice, the passive-braking piston being mounted on the distribution hub by mounting the inner periphery of said central orifice on said cylindrical bearing surface;
the radial portion of the brake counter-disc has an oblique segment extending radially outwards and towards the passive-braking piston;
the passive-braking piston comprises a radial portion and an axial cylindrical portion comprising a pressing end designed to activate the brake;
the axial cylindrical portion of the passive-braking piston comprises an inner cylindrical bearing surface mounted on the brake counter-disc;
the hydraulic brake-release chamber is closed off by two annular seals each positioned between the brake counter-disc and the passive-braking piston;
the brake counter-disc comprises pressing stops angularly distributed over its circumference, facing towards the brake and positioned opposite a shoulder of the outer element;
the brake counter-disc is indexed angularly with the hydraulic distributor and with the outer element by way of pins;
the machine comprises a braking ring which comprises: an annular braking portion designed to activate the brake; and a pressing surface on which the passive-braking piston is designed to press; said pressing surface being radially to the outside with respect to the annular braking portion;
the braking ring comprises through-orifices through which said pressing stops can pass;
the brake counter-disc comprises a drainage duct passing axially right through it;
the distribution hub comprises a drain outlet, and the hydraulic distributor comprises a threaded holding bore, the drainage duct, the drain outlet and the threaded holding bore are designed to be aligned along an axis parallel to the axis of rotation;
the machine comprises a dynamic-braking piston comprising a pressing end which is substantially aligned axially with a pressing end of the passive-braking piston;
the dynamic-braking piston comprises an axial cylindrical portion fitted in between the passive-braking piston and the outer element;
the dynamic-braking piston comprises a sliding hub inserted into a dynamic-braking chamber formed in the outer element;
the brake counter-disc comprises: an axial pressing stop designed to press axially on a complementary bearing surface provided on the passive-braking piston; and at least one threaded bore designed to align with a through-hole made in the distribution hub;
the passive-braking piston comprises an axial pressing stop designed to press against a complementary bearing surface of the dynamic-braking piston.

### BRIEF DESCRIPTION OF THE DRAWINGS

Further features and advantages of the disclosure will become apparent from the nonlimiting description that follows, with reference to the attached drawings in which:

FIG. 1 is a view in cross section of a hydrostatic machine according to the disclosure;

FIG. 2 illustrates the braking ring of the hydrostatic machine of FIG. 1;

FIG. 3 is a perspective illustration of the brake counter-disc 31 of the hydrostatic machine of FIG. 1;

FIG. 4 is a view similar to FIG. 1 for another angular position of the rotor with respect to the stator;

FIG. 5 is a detail view of detail V of FIG. 4;

FIG. 6 is a detail view illustrating a variant of the hydrostatic machine;

FIG. 7 is a perspective view of the hydrostatic machine according to the disclosure;

FIG. 8 and FIG. 9 are detailed cross-sectional views of the hydrostatic machine.

Elements that are similar and common to the various embodiments bear the same reference numerals referring to the figures.

### DETAILED DESCRIPTION

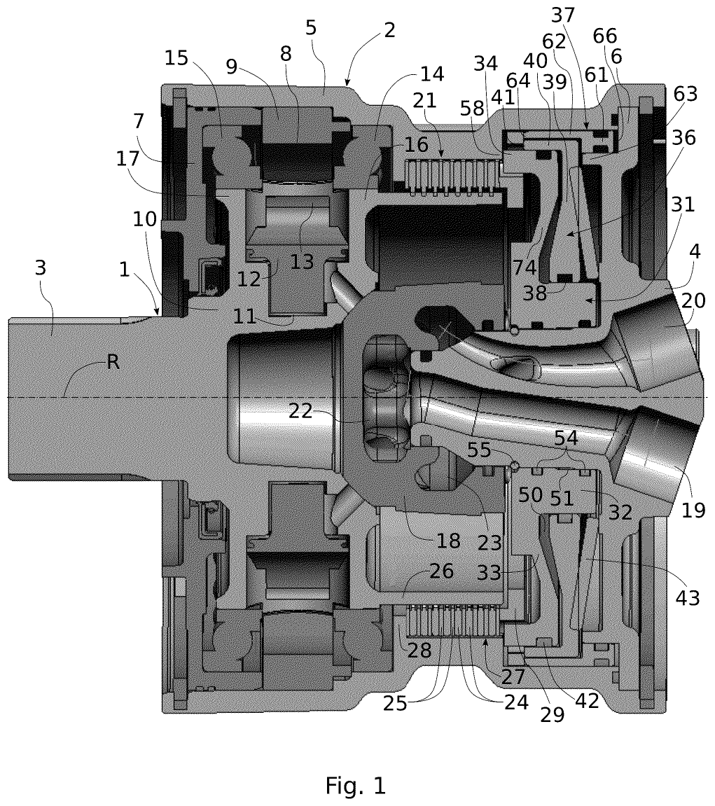

FIG. 1 illustrates a rotary hydrostatic machine according to the disclosure, viewed in section on a plane extending along its axis of rotation R.

This hydrostatic machine is either a hydraulic motor rotationally driving an element by using a pressurized hydraulic fluid, or a hydraulic pump designed to pressurize a hydraulic fluid by using the rotation of an element.

The rotary hydrostatic machine comprises an inner element 1 and an outer element 2 which are mounted with the ability to rotate one relative to the other about the axis of rotation R, by way of rolling bearings 14, 15.

In the present illustrative example, the hydrostatic machine is a hydraulic motor and the inner element 1 is solidly attached to a drive element which here consists of a splined shaft 3.

Of the inner element 1 and the outer element 2 one of these elements is a rotor while the other of these elements is a stator. In the present example, the outer element 2 is a stator and is connected to a support such is a structure that is stationary or carried on board a vehicle, while the inner element 1 is a rotor and the splined shaft 3 is connected for example to a wheel or to a pinion.

The outer element 2 comprises a housing 5, here of tubular shape, with a first cover 6 that hermetically closes one of the openings (on the right in FIG. 1) of this tubular housing 5, and a second cover 7 which hermetically closes the opposite opening (on the left in FIG. 1).

The outer element 2 is additionally solidly attached to a camway 8. In the present example, the hydrostatic machine has radial pistons with a camway 8 forming a circumferential path internal to the wall of the housing 5. This path is made up of dips and of bumps, constituting a cyclic path, with a succession of increasing and decreasing radii, which is synchronized with the in and out movement of pistons 12.

This camway 8 may for example be machined directly on an inner face of the outer element 2, for example machined directly on an inner face of the housing 5. However, as illustrated in the figures, the present example preferably employs a camway 8 borne by a cam ring 9, like the one described in patent application WO2020008145. This cam ring 8 is inserted in the housing 5 of the outer element 2, on an inner surface and is prevented from rotating in any manner.

The inner element 1 for its part comprises a cylinder block 10 which is equipped with cylinders 11 in which pistons 12, in this instance radially mobile pistons, are mounted.

In a known way, the cylinders 11 here are radial cylinders extending over the entire circumference of the cylinder block 10, and uniformly angularly distributed about the axis of rotation R, and the pistons 12 each comprise, on their end that faces towards the camway 8, a roller 13 (viewed in cross section in the various drawings) able to roll without slipping on the camway 8.

The camways for a hydrostatic machine, the collaboration with the radial pistons, and the methods of achieving synchronization by selectively placing cylinders in communication with the hydraulic-fluid circuit, are known from elsewhere and will not be described in greater detail here.

The inner element 1 and the outer element 2 are mounted with the ability to rotate one with respect to the other by virtue, in this example, of a first rolling bearing 14 and a second rolling bearing 15 which are mounted directly between the inner element 1 and the outer element 2. In addition to bearing the cam ring 9, the tubular housing 5 bears these rolling bearings 14, 15. The example in the drawings illustrates two possible ways of mounting the rolling bearings 14, 15 in the housing 5: direct mounting of the rolling bearing with its outer ring in contact with the housing 5 (as is the case with the first rolling bearing 14); and mounting of the rolling bearing in the housing with an intermediate pressing ring (as is the case with the second rolling bearing 15) and in the present example this pressing ring forms part of the second cover 7.

The cylinder block 10 comprises two flanges 16, 17 positioned one on each side of the cylinders 11, with a rolling bearing 14, 15 mounted between each flange 16, 17 and the outer element 2, the inner ring of each rolling bearing 14, 15 being mounted directly on the corresponding flange 16, 17.

The hydrostatic machine additionally comprises a mechanism for distributing and synchronizing hydraulic fluid. The mechanism comprises a hydraulic distributor 18 and a distribution hub 4.

The distribution hub 4 comprises a fluid inlet 19 and a fluid outlet 20 which are connected in the conventional way to the high-pressure and low-pressure portions of a hydraulic circuit. The hydrostatic machine also comprises a drain described later.

The distribution hub 4 is rotationally coupled to the outer element 2. In the present example, the distribution hub 4 is solidly attached to the outer element 2 and is more specifically solidly attached to the first cover 6. The distribution hub 4 is centred on the axis of rotation R.

The hydraulic distributor 18 is mounted on the distribution hub 4 with axial mobility with respect to the latter, the two components being rotationally coupled in any manner, such as pins, that allow axial sliding.

The hydraulic distributor 18 in this example comprises a central chamber 22 and a peripheral chamber 23 which are each connected to the fluid inlet 19 or the fluid outlet 20. FIG. 1 illustrates the connection of the chambers 22, 23 to the fluid inlets/outlets 19, 20 according to the present example.

Seals hermetically partition off the chambers 22, 23 while allowing the axial movement of the hydraulic distributor 18 on the distribution hub 4.

In the known manner, the hydraulic distributor 18 is urged towards the cylinder block 10 such that the hydraulic distributor 18 is designed to connect the cylinders 11 selectively to a hydraulic circuit, by virtue of a synchronization joint that forms a rotary coupling between rotor and stator. In effect, the distribution hub 4 has an increasing diameter producing differential axial thrust on the hydraulic distributor 18 which presses firmly against one another those faces of the hydraulic distributor and of the cylinder block that form this synchronization joint, with a force that is proportional to the pressure of the hydraulic fluid.

In the known manner, the hydraulic fluid is distributed selectively by ducts provided in the cylinder block and the hydraulic distributor 18 as these ducts come into communication at the rotary joint. The cylinders 11 are thus brought selectively into fluidic communication with the high-pressure or low-pressure part of a hydraulic circuit, according to a cycle that is coordinated with the paths of the rollers 13 of the pistons 12 along the camway 8.

The hydrostatic machine additionally comprises a brake 21 designed to oppose the rotation of the rotor with respect to the stator and to halt this relative movement. A set of braking devices is associated with this brake 21 and notably comprises a braking ring 29, a brake counter-disc 31, a passive-braking piston 36, and an optional dynamic-braking piston 37.

The brake 21 works in the conventional way by clamping together a multitude of friction surfaces, there being an alternation of friction surfaces rotationally connected to the rotor and of friction surfaces rotationally connected to the stator.

The brake 21 in this example comprises, arranged in alternation:
a series of inner discs 24, rotationally coupled with the inner element 1;
a series of outer discs 25, rotationally coupled with the outer element 2;

The discs 24, 25, although rotationally coupled to the inner element 1 or to the outer element 2, are axially mobile.

In the known way, the inner discs 24 and/or the outer discs 25 may be fitted with conventional braking-element friction linings.

As the rotor rotates with respect to the stator, the clamping-together of this set of discs 24, 25 causes the braking of the rotor with respect to the stator.

In the present example, and particularly advantageously, the brake 21 is positioned around the hydraulic distributor 18, as described in document EP3233553. In this example, one of the flanges 16 of the cylinder block 10 has a collar 26 which has the overall shape of the cylinder coaxial with the axis of rotation R and which surrounds the hydraulic distributor 18. The collar 26 is itself surrounded by the brake 21, the axial length of the brake 21 being similar to the axial length of the hydraulic distributor 18.

The collar 26, as a component belonging to the internal element 1, bears on its radially exterior face rotational-coupling mechanism, such as splines, for coupling to the inner discs 24 (the latter bearing teeth that complement these splines). The inner discs 24 are thus rotationally coupled with the inner element 1, while having the ability to slide axially with respect thereto.

The outer element 2, at the housing 5 in this example, comprises a tubular braking portion 27 extending coaxially with respect to the axis of rotation R and surrounding the collar 26. This tubular braking portion 27 on its radially inner face has splines, and the outer discs 25 on their outer periphery have complementing teeth. The outer discs 25 are thus rotationally coupled with the outer element 2, while having the ability to slide axially with respect thereto.

The tubular braking portion 27 comprises a pressing rib 28, which contributes to the stiffness of the housing 5, allowing its size, notably its thickness, to be reduced and also acting as an end stop for the brake 21.

The hydrostatic machine additionally comprises a braking ring 29 which is designed to activate the brake 21 by pressing on the stack of discs 24, 25.

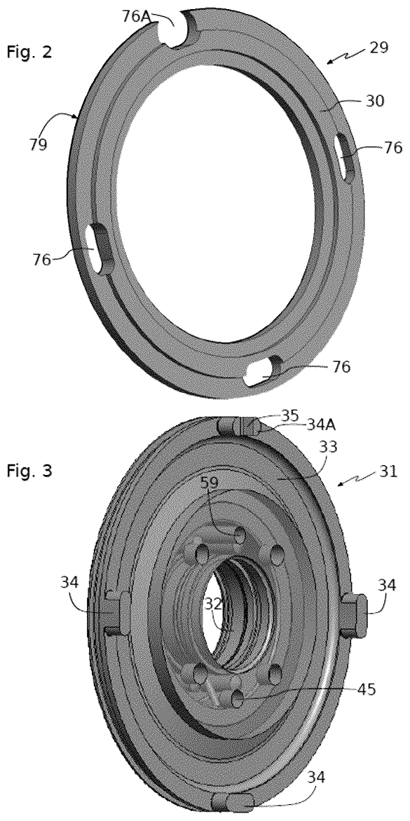

The braking ring 29 is depicted by itself, in perspective, in FIG. 2. This braking ring 29 comprises, on one side, a pressing surface 79 and, on the other side, an annular braking portion 30 projecting axially towards the brake 21. The pressing surface 79 is of a greater diameter than the annular braking portion 30. In other words, the pressing surface 79 is situated radially to the outside with respect to the annular braking portion 29.

The braking ring 29 is axially mobile and allows the discs 24, 25 of the brake 21 to be compressed between the pressing rib 28 and the annular braking portion 30, in response to a force applied to the pressing surface 79.

The hydrostatic machine additionally comprises a brake counter-disc 31 which is mounted on the distribution hub 4 and which extends radially around the distribution hub 4.

The brake counter-disc 31 is also depicted by itself, in perspective, in FIG. 3.

The brake counter-disc 31 in this example comprises:
a central ring 32, extending in the axial direction, with a bore centred on the axis of rotation R, and mounted on the distribution hub 4;
a radial portion 33 formed by a solid disc portion extending between the central ring 32 and the periphery of the brake counter-disc 31;
four pressing stops 34 projecting axially from the periphery of the brake counter-disc 31 and angularly distributed over the circumference thereof, one of these pressing stops, 34A, comprising an angular-indexing slot 35.

The braking mechanism additionally comprise a passive-braking piston 36 able to activate the brake 21 in the absence of hydraulic-fluid pressure. This passive braking is used for example for parking braking.

The passive-braking piston 36 is a component with symmetry of revolution, having the same profile over its entire circumference, this profile being visible in cross section in FIG. 1.

The passive-braking piston 36 is mounted on the central ring 32 of the brake counter-disc 31. The central ring 32 for this purpose has, on its radially outer face, a cylindrical bearing surface 77 on which the passive-braking piston 36 can be mounted and guided in axial translation. The passive-braking piston 36 has a central orifice, centred on the axis of rotation R, and the inner contour of which is fitted as a sliding fit onto the cylindrical bearing surface 77 of the brake counter-disc 31.

The passive-braking piston 36 is mounted on the central ring 32 via an annular seal 38 which provides sealing, in this region, between the brake counter-disc 31 and the passive-braking piston 36.

The passive-braking piston 36 comprises a radial portion 39, in the form of a solid disc portion extending from the central orifice which allows the passive-braking piston 36 to be mounted on the brake counter-disc 31. The passive-braking piston 36 additionally comprises an axial cylindrical portion 40 extending coxially with respect to the axis of rotation R, from the periphery of the radial portion 39. The axial cylindrical portion 40 has a pressing end 41 designed to activate the braking. The axial cylindrical portion 40 comprises an inner cylindrical bearing surface 78 (mounted on the brake counter-disc 31). Another annular seal 42 provides sealing between the inner cylindrical bearing surface 78 and the circumferential edge of the brake counter-disc 31, so as to provide sealing, in this region, between the brake counter-disc 31 and the passive-braking piston 36.

The passive-braking piston 36 is thus able to move axially with respect to the brake counter-disc 31 by virtue of the sliding allowed by the two seals 38, 42 at the two coaxial cylindrical bearing surfaces 77, 78 which are formed at the central ring 32 of the brake counter-disc 31 and at the axial cylindrical portion 40 of the dynamic-braking piston 37.

The passive-braking piston 36, given its function, is urged to activate the brake 21 by an elastic element 43. In the present example, this elastic element 43 is a conical spring washer of the “Belleville” spring washer type. The elastic element 43 urges the passive-braking piston 36 towards the brake 21, and towards the brake counter-disc 31.

In the schematic views of the figures, the elastic element 43 is depicted in its position of rest, in the absence of urging, this being indicated schematically as interpenetration between the elastic element 43 and the passive-braking piston 36. In real life, when mounting these elements, the elastic element 43 will bear against the passive-braking piston 36 and deform elastically, applying a force that tends to push the passive-braking piston 36 back from the first cover 6. The force thus created between these two elements means that, at rest, in the absence of any other urging influence, the pressing end 41 of the axial cylindrical portion 40 of the passive-braking piston 36 will be pressed against the pressing surface 79 of the braking ring 29, activating the brake 21 and immobilizing the rotor with respect to the stator.

The elastic element 43 is dimensioned such that the force applied in this situation exerts the braking force required, accounting for the system as a whole, to immobilize the rotor with respect to the stator.

In the present example, the elastic element 43 is positioned between the passive-braking piston 36 and the first cover 6 of the outer element 2.

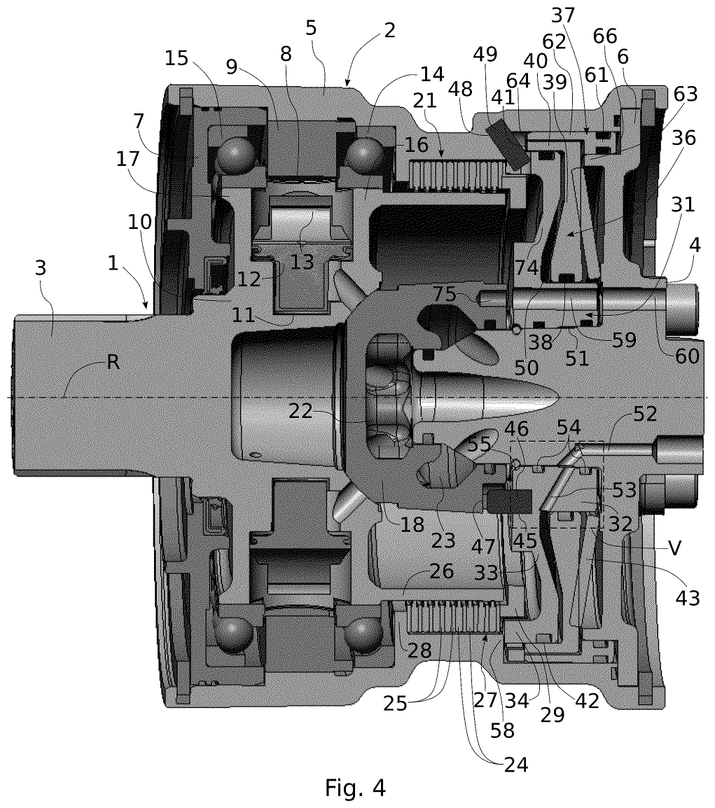

FIG. 4 is a view similar to FIG. 1 for another angular position of the rotor with respect to the stator. This FIG. 4 shows an angular-indexing orifice 45 (also visible in FIG. 3) made in the brake counter-disc 31, in the central ring 32 thereof. A pin 46 fits into this orifice 45 and is also inserted into an angular-indexing orifice 47 of the hydraulic distributor 18. This then ensures the angular indexing of the distributor 18 with respect to the brake counter-disc 31.

In addition, the outer element 2 (and more specifically the housing 5 in this example) also comprises an angular-indexing orifice 48 which likewise accepts a pin 49, the latter also being fitted into the angular-indexing slot 35 of the pressing stop 34A of the brake counter-disc 31. This then ensures the angular indexing of the brake counter-disc 31 with respect to the outer element 2.

The brake counter-disc 31 is thus a unique component which, directly and on its own, provides angular indexing of the hydraulic distributor 18 with respect to the outer element 2. The brake counter-disc 31 is a component having symmetry of revolution that can be machined on a lathe, without altering the grip on the workpiece, so that its two angular-indexing elements 35, 45 can be created with a high level of mechanical precision. Precise angular indexing, which is of prime importance to the operation of the hydraulic distributor 18, with a very low level of spread, is thus guaranteed, at a lower cost.

With reference to FIG. 3, the braking ring 29 comprises through-orifices 76 through which said pressing stops 34 can pass. One of these orifices, 76A, takes the form of a cutout that additionally allows the pin 49 to pass.

Moreover, with reference to FIGS. 1 and 4, a hydraulic brake-release chamber 50 is positioned between the brake counter-disc 31 and the passive-braking piston 36. In the present example, the brake counter-disc 31 and the passive-braking piston 36 between them delimit the hydraulic brake-release chamber 50 thanks to the fact that each of these elements is made up of a radial component 33, 39 and of an axial component 32, 40 mounted top to tail, and by virtue of the annular seals 38, 42 that allow fluidtight relative axial translational movement along the two coaxial cylindrical bearing surfaces 77, 78.

Thus, when the hydraulic brake-release chamber 50 is pressurized by the hydraulic fluid, a separating force is created between the brake counter-disc 31 and the passive-braking piston 36. When designing the hydrostatic machine, the volume of the hydraulic brake-release chamber 50 may be adjusted by the difference in diameter between the two annular seals 38, 42, and can thus be tailored to the force desired for releasing the passive braking, without detriment to the improved lengthwise compactness of the hydrostatic machine.

The arrangement of the brake counter-disc 31 offers the advantage of allowing the use of a central ring 32 of relatively large inside diameter, which in turn makes it possible to provide a distribution hub 4 of a diameter great enough to house fluid-inlet ducts 19 and fluid-outlet ducts 20 that induce only small pressure drops, and to do so without detriment to the braking performance and while remaining very compact, notably in terms of length. In the present example (see FIG. 1), these fluid inlet ducts 19 and fluid outlet ducts 20 advantageously have a large diameter and follow paths close to straight lines, without bends.

In order to supply the hydraulic brake-release chamber 50 with hydraulic fluid, the hydrostatic machine comprises an annular supply chamber 51 between the brake counter-disc 31 and the distribution hub 4. A hub duct 52 (which opens to the outside, onto the distribution hub 4, in order to be connected to the hydraulic circuit) and a transmission duct 53 (which additionally opens into the hydraulic brake-release chamber 50) both open into the annular supply chamber 51.

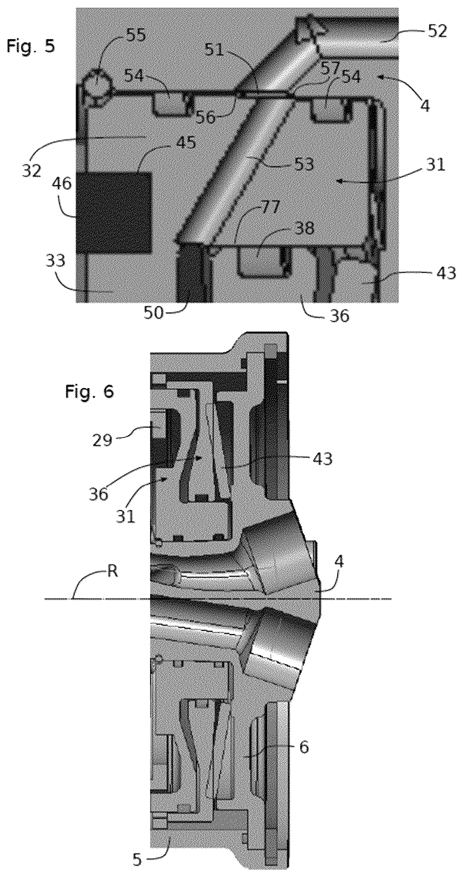

FIG. 5 is a detail view of detail V of FIG. 4 and shows the mounting of the brake counter-disc 31 on the distribution hub 4.

Two annular seals 54 are positioned between the brake counter-disc 31 and the distribution hub 4, defining between them a fluidtight space in the gap between these two components. The annular supply chamber 51 is positioned between these two annular seals 54.

In this example, the annular supply chamber 51 is made up of a first discontinuity 56 in the diameter of the central ring 32 of the brake counter-disc 31, and of a second discontinuity 57 in the diameter of the distribution hub 4. These two discontinuities 56, 57 complement one another and are axially separated in such a way that the annular supply chamber 51 is defined by these two discontinuities 56, 57 and is rendered fluidtight by the two annular seals 54.

This configuration enables the creation of the annular supply chamber 54 while maintaining optimal axial guidance of the translational movement of the brake counter-disc 31 on the distribution hub 4. In addition, during manufacture of the hydrostatic machine, by virtue of the change in the diameter of the components that is brought about by the discontinuities 56, 57, the brake counter-disc 31 can be mounted by sliding it onto the distribution hub 4, such that the first annular seal 54 encounters no cavity other than its own bearing surface, with the same being true for the second annular seal 54. The two annular seals 54 are thus slid along their respective bearing surface without encountering any sharp edge, which constitutes a critical point with this type of mounting.

The brake counter-disc 31 is free to slide axially by axial translation of the central ring 32 on the hydraulic distributor 4, by virtue of the sliding of the annular seals 54 over a travel which is confined: on the one side by an end stop formed by contact between the central ring 32 and the distribution hub 4 or the first cover 6; and on the other side by an end stop 55 which, in this example, consists of an elastic snap ring. The end stop 55 is able to form an end-of-travel stop for the translational movement of the brake counter-disc 31 in the direction of the brake 21.

The construction of the annular supply chamber 51 allows this axial sliding while remaining intact.

The passive-braking function is implemented as follows.

With no activation of the hydraulic circuit at the hydraulic brake-release chamber 50, the elastic element 43 urges the passive-braking piston 36 towards the brake 21 so that its pressing end 41 pushes back the braking ring 29 which itself compresses the set of discs 24, 25 of the brake 21. Given the calibration of the elastic element 43 to take account of the nature of the discs 24, 25, this operation brings about the braking and the immobilization of the rotor with respect to the stator.

When the hydrostatic machine is brought into operation, with a view to causing the rotor to rotate with respect to the stator, the hydraulic brake-release chamber 50 is pressurized by the hydraulic fluid conveyed in by the hub duct 52 (which duct is connected to the hydraulic circuit), the annular supply chamber 51 and the transmission duct 53.

This pressurizing of the hydraulic brake-release chamber 50 causes the brake counter-disc 31 to be brought into abutment against its end stop 55 and a backing-off axial movement of the passive-braking piston 36, which then moves away from the brake counter-disc 31, compressing the elastic element 43. This causes a release of the stress applied to the braking ring 29 and therefore releasing of the brake 21.

As soon as the pressure in the hydraulic brake-release chamber 50 is no longer maintained, the passive-braking piston 36 returns to its position of clamping the brake 21 on, under the effect of the elastic element 43.

In normal operation, or in the event of overpressure in the hydraulic brake-release chamber 50, the brake counter-disc 31 deforms and the four pressing stops 34 come to press against a shoulder 58 of the outer element 2 (in the present example, the shoulder 58 is formed directly in the housing 5). For this purpose, when the system is at rest, the dimension of the brake counter-disc 31 is such that the pressing stops 34 exhibit a small amount of axial clearance with respect to the shoulder 58, for example a clearance of less than 1 mm.

A large-diameter brake counter-disc 31 may thus advantageously be used, without detriment to its operation.

The braking ring 29 allows the pressure of the passive-braking piston 36 to be received on a diameter that is radially far towards the outside (its pressing surface 79), near the housing 5, while allowing this pressure to be passed on over a smaller diameter on its annular braking portion 30. This action on a smaller diameter corresponding to the brake 21, from a larger diameter, means that the passive-braking piston 36 can be configured with an axial cylindrical portion 40 of small thickness and great axial length, but large diameter, making it a component that is rigid and forms a large-diameter bearing surface for sealing at the annular seal 42.

The cross-sectional view of FIG. 4 also shows a drainage duct 59 made in the brake counter-disc 31, in the central ring 32 thereof, and passing axially right through it. The drainage duct 59 is also visible in FIG. 3.

The drainage duct 59 allows fluidic communication right through the brake counter-disc 31, so that there is no element partitioning off this hydraulic fluid, and so that just a single drain outlet 60 on the distribution hub 4 is needed for draining the hydraulic fluid, despite the presence of the brake counter-disc 31.

The hydrostatic machine in this example additionally comprises a dynamic-braking piston 37 providing an active braking function under the effect of a positive command applied to a brake actuator by an operator or by a device.

The dynamic-braking function is optional here and the hydrostatic machine is of near-identical construction regardless as to whether or not this dynamic-braking function is employed. FIG. 6 therefore illustrates a variant without the dynamic-braking function, in a partial sectioned view confined to these elements.

When this dynamic-braking function is implemented, as in FIGS. 1 and 4, the hydrostatic machine comprises a dynamic-braking piston 37 which has a sliding hub 61 and an axial cylindrical portion 62.

The sliding hub 61 is fitted with seals and is inserted in a dynamic-braking chamber 66 which is made in the outer element 2. In this example, the dynamic-braking chamber 66 is particularly advantageously formed by a simple tubular projection 63 of the first cover 6, making use of adjacent inner surface of the housing 5, at the junction where the first cover 6 meets the housing 5.

The axial cylindrical portion 62 of the dynamic-braking piston 37 is fitted (as a sliding fit) in between the axial cylindrical portion 40 of the passive-braking piston 36 and the outer element 2 (in this example the housing 5).

The axial cylindrical portion 62 of the dynamic-braking piston 37 comprises a pressing end 64 which is substantially aligned axially with a pressing end 41 of the axial cylindrical portion 40 of the passive-braking piston 36. These two pressing ends 41, 64 are thus both capable of applying pressure to the pressing surface 79 of the braking ring 29, which is situated opposite them.

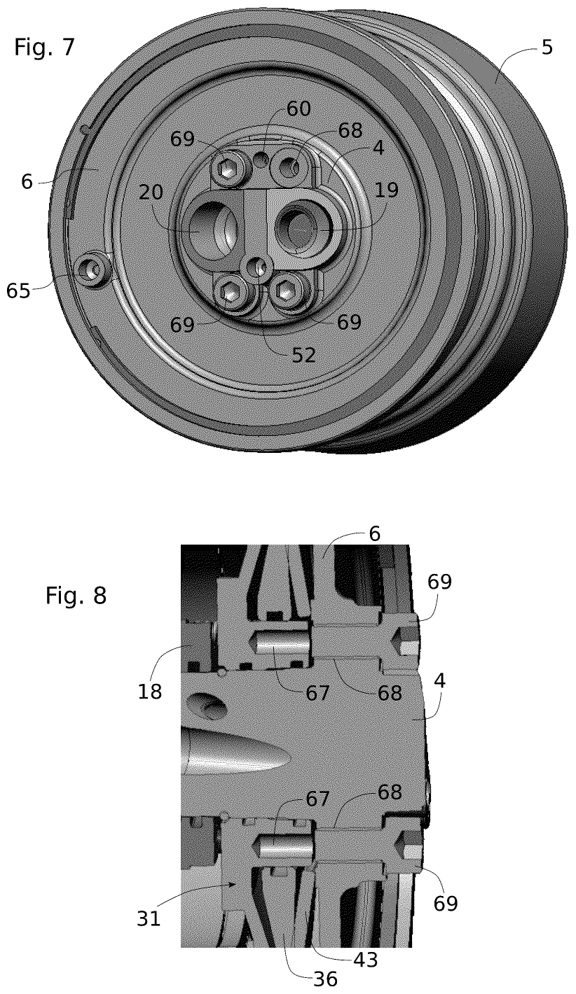

FIG. 7 is a perspective view illustrating the hydrostatic machine viewed from the outside, from the side comprising the first cover 6. FIG. 7 shows a dynamic-braking duct 65 which is made in the outer element 2 (in the cover 6 in this example). This dynamic-braking duct 65 is extremely short (it corresponds to the thickness of the first cover 6) and opens directly into the dynamic-braking chamber 66.

In order to implement the dynamic-braking function during operation of the hydrostatic machine, the dynamic-braking chamber 66 is therefore pressurized with the hydraulic fluid conveyed by the dynamic-braking duct 65. The dynamic-braking piston 37 is then made to translate axially towards the brake 21, so that its pressing end 64 acts on the braking ring 29 and activates the brake 21.

It is emphasised that the dynamic-braking piston 37 advantageously requires for its translational movement no further guidance other than having been fitted between the passive-braking piston 36 and the outer element 2. A very compact fit is thus obtained for one, or even two, braking functions. In addition, the hydrostatic machine also remains compact, whether or not the optional dynamic-braking function is employed.

The brake counter-disc 31 also has an additional function of releasing the brake for maintenance operations or in the event of a fault. FIG. 8 is a partial sectioned view illustrating a portion of the inner element 1 and of the outer element 2, around the distribution hub 4, for another angular position of the rotor with respect to the stator, revealing threaded bores 67 that are made in the central ring 32 of the brake counter-disc 31.

In this example, these threaded bores 67 are 4 in number and angularly distributed over the circumference of the brake counter-disc 31.

These threaded bores 67 match up with through-holes 68 made in the distribution hub. In this example, these three-holes 68 are threaded bores of a larger diameter than the threaded bores 67 and which, in normal operation, are plugged in a fluidtight manner by screws 69. The screws 69 and one of the threaded bores 68 are also visible in FIG. 7.

According to this brake-release function, in the event of a breakdown or for the purposes of maintenance operations, it is possible to release all the braking functions by positioning the rotor with respect to the stator (through a relative rotation of at most one quarter of a revolution) until the threaded bores 67, 68 come into alignment, extracting the screws 69, then inserting maintenance screws having the diameter of the screw thread of the threaded bores 67 of the brake counter-disc 31 so that tightening these maintenance screws pulls the brake counter-disc 31 towards the first cover 6 over a travel that is sufficient to release both the passive-braking piston 36 and the dynamic-braking piston 37, if the latter is present.

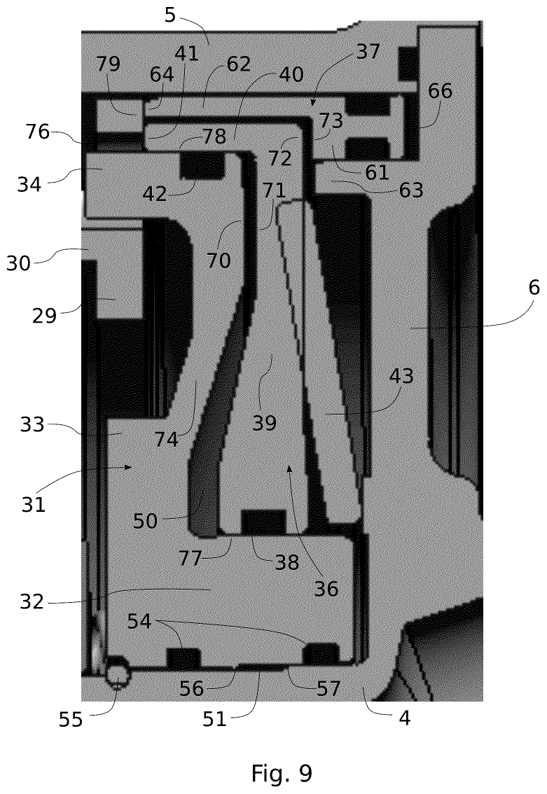

FIG. 9 is a detail view notably illustrating the arrangement of the pressing stop elements that allow this brake-release function. The brake counter-disc 31 comprises an axial pressing stop 70 designed to push back on a complementary bearing surface 71 on the passive-braking piston 36, and the passive-braking piston 36 also comprises an axial pressing stop 72 designed to push back on a complementary bearing surface 73 on the dynamic-braking piston 37.

The axial pressing stop 70 of the brake counter-disc 31 is produced by virtue of an oblique segment 74 of the radial portion 33, which extends radially outwards and towards the passive-braking piston 36. This oblique segment 74 also makes it possible to improve the compactness of the hydrostatic machine.

Moreover, with reference to FIG. 4, the hydraulic distributor 4 may comprise a threaded angular-indexing bore 75, accessible through the drainage duct 59 and the drain outlet 60 and making it possible, during the manufacture of the hydrostatic machine, to insert a threaded gauge rod that angularly indexes and holds the hydraulic distributor 18 on the distribution hub 4 in order to hold these elements together during assembly.

Embodiment variants may be envisioned. Notably, the entire hydraulic-distribution part and the part providing the collaboration between the pistons 12 and the camway 8 may differ from that given by way of example here. Moreover, the rotational coupling of the brake counter-disc 31 with the outer element 2 may be achieved using other alternatives, for example by tightly fitting the brake counter-disc 31 on the distribution hub 4.

What is claimed is:

1. A rotary hydrostatic machine, comprising:
an inner element and an outer element which are coaxial and mounted with the ability to rotate one with respect to the other about an axis of rotation, one of these elements being a rotor and the other of these elements being a stator;
pistons configured to move in cylinders and collaborating with a camway in a manner that is coordinated with the rotation of the rotor with respect to the stator;
a distribution hub rotationally coupled to the outer element;
a hydraulic distributor mounted on the distribution hub and designed to connect the cylinders selectively to a hydraulic circuit;
a brake designed to oppose the rotational movement of the rotor with respect to the stator;
a brake counter-disc which is mounted on the distribution hub, which extends radially around the distribution hub, and which is rotationally coupled to the outer element;
a passive-braking piston designed to activate said brake under the effect of an elastic element and which is mounted with axial mobility with respect to the brake counter-disc; and
a hydraulic brake-release chamber positioned between the brake counter-disc and the passive-braking piston.

2. The rotary hydrostatic machine according to claim 1, wherein the brake counter-disc is mounted with axial translational mobility on the distribution hub.

3. The rotary hydrostatic machine according to claim 2, further comprising an end stop configured to halt the axial translation of the brake counter-disc in the direction of the brake.

4. The rotary hydrostatic machine according to claim 1, further comprising an annular supply chamber positioned between the distribution hub and the brake counter-disc, the annular supply chamber being connected on the one hand to the hydraulic brake-release chamber and on the other hand to a hub duct extending from the distribution hub.

5. The rotary hydrostatic machine according to claim 4, wherein the annular supply chamber is delimited by two annular seals positioned between the distribution hub and the brake counter-disc.

6. The rotary hydrostatic machine according to claim 4, wherein the annular supply chamber is defined by two mutually complementing discontinuities in diameter of, respectively, the distribution hub and the brake counter-disc.

7. The rotary hydrostatic machine according to claim 1, wherein the brake counter-disc comprises (i) a central ring extending axially and mounted on the distribution hub, and (ii) a radial portion extending radially from the central ring.

8. The rotary hydrostatic machine according to claim 7, wherein:
the central ring of the brake counter-disc comprises an outer cylindrical bearing surface, and
the passive-braking piston is a component with symmetry of revolution comprising a central orifice, the passive-braking piston being mounted on the distribution hub by mounting the inner periphery of said central orifice on said cylindrical bearing surface.

9. The rotary hydrostatic machine according to claim 7, wherein the radial portion of the brake counter-disc has an oblique segment extending radially outwards and towards the passive-braking piston.

10. The rotary hydrostatic machine according to claim 1, wherein the passive-braking piston comprises a radial portion and an axial cylindrical portion comprising a pressing end designed to activate the brake.

11. The rotary hydrostatic machine according to claim 10, wherein the axial cylindrical portion of the passive-braking piston comprises an inner cylindrical bearing surface mounted on the brake counter-disc.

12. The rotary hydrostatic machine according to claim 1, wherein the hydraulic brake-release chamber is closed off by two annular seals each positioned between the brake counter-disc and the passive-braking piston.

13. The rotary hydrostatic machine according to claim 1, wherein the brake counter-disc comprises pressing stops angularly distributed over its circumference, facing towards the brake, and positioned opposite a shoulder of the outer element.

14. The rotary hydrostatic machine according to claim 1, wherein the brake counter-disc is indexed angularly with the hydraulic distributor and with the outer element by way of pins.

15. The rotary hydrostatic machine according to claim 1, further comprising a braking ring which includes (i) an annular braking portion designed to activate the brake, and (ii) a pressing surface on which the passive-braking piston is designed to press, said pressing surface being radially to the outside with respect to the annular braking portion.

16. The rotary hydrostatic machine according to claim 15, wherein:
the brake counter-disc comprises pressing stops angularly distributed over its circumference, facing towards the brake, and positioned opposite a shoulder of the outer element, and
the braking ring comprises through-orifices through which said pressing stops are configured to pass.

17. The rotary hydrostatic machine according to claim 1, wherein the brake counter-disc comprises a drainage duct passing axially through the rotary hydrostatic machine.

18. The rotary hydrostatic machine according to claim 17, wherein:
the distribution hub comprises a drain outlet, and the hydraulic distributor comprises a threaded holding bore, and
the drainage duct, the drain outlet, and the threaded holding bore are designed to be aligned along an axis parallel to the axis of rotation.

19. The rotary hydrostatic machine according to claim 1, further comprising a dynamic-braking piston that includes a pressing end which is substantially aligned axially with a pressing end of the passive-braking piston.

20. The rotary hydrostatic machine according to claim 19, wherein:
the dynamic-braking piston comprises an axial cylindrical portion fitted in between the passive-braking piston and the outer element,
the dynamic-braking piston further comprises a sliding hub inserted into a dynamic-braking chamber formed in the outer element,
the brake counter-disc comprises (i) an axial pressing stop designed to press axially on a complementary bearing surface provided on the passive-braking piston, and (ii) at least one threaded bore designed to align with a through-hole made in the distribution hub, and
the passive-braking piston comprises an axial pressing stop designed to press against a complementary bearing surface of the dynamic-braking piston.
